(19) United States
(12) Patent Application Publication
(10) Pub. No.: US 2009/0195579 A1
(43) Pub. Date: Aug. 6, 2009

(54) INKJET PRINTING SYSTEM AND METHOD OF PRINTING

(76) Inventors: Susan H. Tousi, Poway, CA (US); Steven A. Billow, Victor, NY (US); Richard C. Reem, Hilton, NY (US)

Correspondence Address: David A. Novais;Patent Legal Staff, Eastman Kodak Company, 343 State Street, Rochester, NY, 14650-2201, US

(21) Appl. No.: 12/026,935

(22) Filed: Feb. 6, 2008

(51) Int. Cl. B41J 29/38

(52) U.S. Cl. 347/14

(57) ABSTRACT

A method of printing comprises providing a carriage-type inkjet printer having a printhead, with the printer being responsive to digital signals and capable of printing in a multi-pass printing mode, supplying the printer with pigment-based inks, supplying the printer with a receiver surface suitable for printing of photographic images, detecting a degree of texturing on the receiver surface, selecting a number of passes for the multi-pass printing mode based on the detected degree of texturing of the receiver surface, and passing the print head over the receiver surface in accordance with the selected number of passes.

### FIELD OF THE INVENTION

This invention pertains to the field of inkjet printing systems, and more particularly to a method for reducing gloss artifacts in inkjet prints.

### BACKGROUND OF THE INVENTION

Ink jet printing is a non-impact method for producing printed images by the deposition of ink droplets in a pixel-by-pixel manner to an image-recording element medium or receiver in response to digital data signals. There are various methods that may be utilized to control the deposition of ink droplets on the image-recording element to yield the desired printed image. In one process, known as drop-on-demand ink jet, individual ink droplets are projected as needed onto the image-recording element to form the desired printed image. Common methods of controlling the projection of ink droplets in drop-on-demand printing include piezoelectric transducers and thermal bubble formation.

An inkjet recording element typically comprises a support having on at least one surface thereof at least one ink-receiving layer. There are generally two types of ink-receiving layers (IRL's). The first type of IRL comprises a non-porous coating of a polymer with a high capacity for swelling, which non-porous coating absorbs ink by molecular diffusion. Cationic or anionic substances may be added to the coating to serve as a dye fixing agent or mordant for a cationic or anionic dye. Typically, the support is a smooth resin-coated paper and the coating is optically transparent and very smooth, leading to a very high gloss “photo-grade” inkjet recording element. However, this type of IRL usually tends to absorb the ink slowly and, consequently, the printing process is relatively slow and the imaged receiver or print is not instantaneously dry to the touch.

The second type of ink-receiving layer or IRL comprises a porous coating of inorganic, polymeric, or organic-inorganic composite particles, a polymeric binder, and optional additives such as dye-fixing agents or mordants. These particles can vary in chemical composition, size, shape, and intra-particle porosity. In this case, the printing liquid is absorbed into the open interconnected pores of the IRL, substantially by capillary action, to obtain a print that is instantaneously dry to the touch. Typically the total interconnected inter-particle pore volume of porous media, which may include one or more layers, is more than sufficient to hold all the applied ink forming the image.

The ink droplets, or recording liquid, generally comprise a recording agent, such as a dye or pigment, and a large amount of solvent. The solvent, or carrier liquid, typically is made up of an aqueous mixture, for example, comprising water and one or more organic materials such as a monohydric alcohol, a polyhydric alcohol, or the like. Dye-based inks may be printed quickly on porous inkjet receivers, but are known to have poor image durability characteristics, and are subject to fading or damage over time with exposure to light, pollutants or moisture. Methods such as fusing, lamination and overcoating may be employed to improve image stability of dye-based images on porous media. However, each of these methods suffers from multiple drawbacks, including extra steps, more complex apparatus, substantial energy and/or extra material. On the other hand, pigment-based inks are known for image stability on porous receivers. Previously, pigment-based inks were jetted from piezo-driven printheads and were limited to relatively slow ejection rates. Recently Dietl, et al., in US 2006/0103691 described a fluid ejection device and printhead capable of high speed printing with pigment-based inks.

Economically-priced, compact inkjet printers designed for personal use in the home or small office are generally of the carriage type, wherein the printhead does not span the entire width of the receiver, but is scanned across the receiver in a direction perpendicular to the direction of travel of the receiver during the printing process. The paper is then advanced so that the printhead can print the next swath. In a bi-directional printing mode, ink is jetted during both directions of travel of the printhead, thus approximately doubling the throughput. In order to improve print quality, a multi-pass mode may be employed, in which the receiver is advanced only a fraction of the length of the nozzle array after a printing swath has been completed. This mode provides the opportunity to jet additional droplets on or near previously printed dots. Several advantages accrue from multi-pass printing, such as controlling the order in which different inks are deposited, reducing coalescence of ink droplets, and mitigation of drop-placement errors. The trade-off for multi-pass printing is a reduction in throughput by a factor approximately corresponding to the reciprocal of the number of passes.

An attribute of photographic-quality prints is gloss. The term “gloss” refers to light that is reflected off of the front surface of the print, and appears when an image is viewed in a near specular orientation. Pigmented inks are known to provide good image durability characteristics, but can suffer from gloss artifacts (any unexpected appearance of gloss) that result in a perceived image quality loss. These gloss artifacts include “differential gloss”, which is an abrupt change in gloss appearing between two adjacent regions in an image; “chromatic gloss”, which is a change in the color of the gloss that appears when an image is viewed in a near specular orientation; and “haze”, which refers to a cloudy or smoky appearance to an image resulting from light scattering off of the surface of the print.

A measure to remove gloss artifacts is to print on a matte receiver, such that Lambertian scattering of the first surface reflection removes gloss entirely. The drawbacks of this measure include loss of maximum print density, decreased dynamic range of print density, and of course lack of gloss. Therefore, some consumers will not receive a matte receiver for a photographic print.

Several methods to address the gloss artifacts described above are known in the art. One technique known in the art is to laminate the print, but this is typically too time-consuming and costly. Another technique is to apply an additional, substantially clear ink to the entire image during or shortly after the printing process. For example, see U.S. Pat. Nos. 6,428,157, and 6,561,644. The application of a full layer of clear ink on top of an area printed with pigmented inks is likely unnecessary to achieve the desired mitigation of gloss artifacts, and is wasteful of ink. Also, indiscriminate application of clear ink leads to a dramatic increase in the total amount of fluid deposited on the page, which is known to cause other negative image quality artifacts. See for example U.S. Pat. No. 6,435,657.

Other techniques known in the art attempt to minimize differential gloss by applying a clear ink in unprinted areas. See for example U.S. Pat. Nos. 6,857,733; 6,953,244; and 6,863,392.

In U.S. Pat. No. 6,877,850, a method of applying clear ink based on the total duty of the colored ink is disclosed. Similarly, U.S. Pat. No. 6,585,363 to Tanaka, et al., discloses a method of applying a clear ink in which the CMYK ink amounts are summed to generate a map of printed pixels. The map is then “thinned” using a masking process to determine which locations will receive the clear ink.

With these advances, it has been possible to provide glossy photographic-quality images of good durability and image fastness on dry-to-the-touch porous media at high printing speeds. However, some gloss artifacts persist. In particular for bi-directional, multipass printing modes, there remains a gloss artifact in the form of bands of alternating gloss level, where the period of the gloss variation corresponds to the distance of the page advance steps during printing. While the appearance of this banding can be reduced by increasing the number of passes, the result is an undesirable slower printing speed.

### SUMMARY OF THE INVENTION

It is an object of the present invention to reduce the printing time for high-quality photographic prints made with durable, fade-resistant pigment-based inks on porous-type inkjet receivers that are immediately dry to the touch upon exit from the printer. A further object of the present invention is to provide improved image quality by reducing undesirable gloss-artifacts.

These objects are achieved by a method of printing comprising the steps of

providing a carriage-type inkjet printer having a printhead, the printer being responsive to digital signals and capable of printing in a multi-pass printing mode,

supplying the printer with pigment-based inks,

supplying the printer with a receiver suitable for printing of photographic images,

detecting a degree of texturing of a surface of the receiver,

selecting a number of passes for the multi-pass printing mode based on the detected degree of texturing of the receiver surface, and

passing the printhead over the receiver surface in accordance with the selected number of passes.

### BRIEF DESCRIPTION OF THE DRAWINGS

FIG. 1 is a functional block diagram of a printing system in accordance with one embodiment illustrating principles of the present invention;

FIG. 2 is a schematic representation of a printhead in accordance with one embodiment illustrating principles of the present invention;

FIG. 3 is a portion of a carriage printer in accordance with one embodiment illustrating principles of the present invention;

FIG. 4 is a schematic view of the printer rollers in accordance with one embodiment illustrating principles of the present invention; and

FIG. 5 is a flow chart describing one embodiment of the invention.

### DETAILED DESCRIPTION OF THE INVENTION

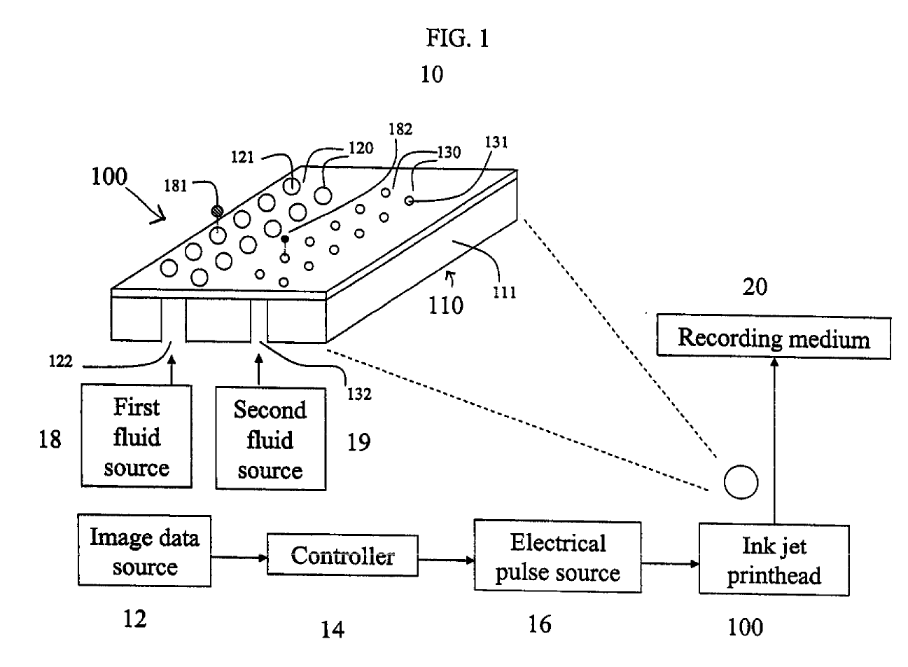

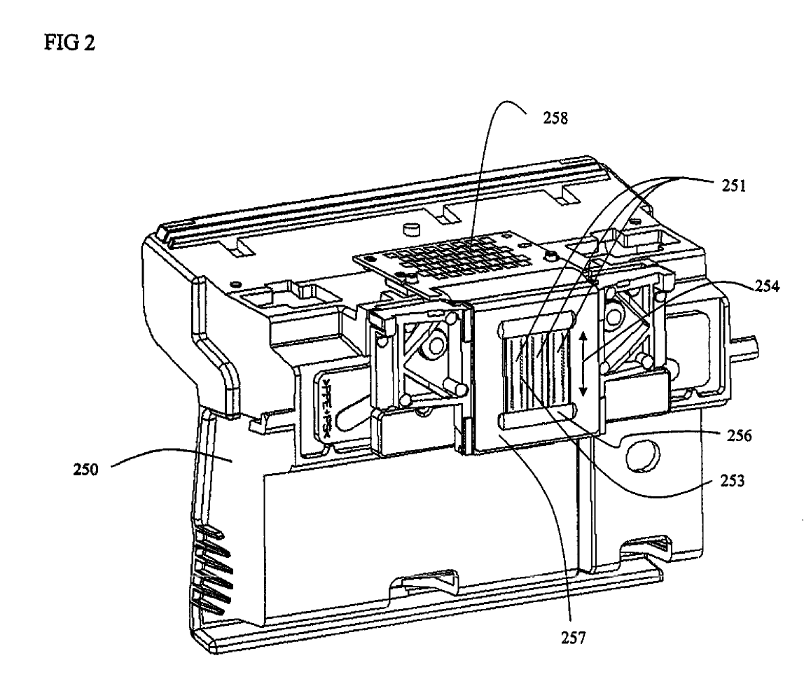

Referring to FIG. 1, a schematic representation of an inkjet printer system 10 is shown, as described in US 2006/0103691 A1. The system includes a source 12 of image data which provides signals that are interpreted by a controller 14 as being commands to eject drops. Controller 14 outputs signals to a source 16 of electrical energy pulses which are inputted to the inkjet printhead 100 which includes at least one printhead die 110. In the example shown in FIG. 1, there are two nozzle arrays. Nozzles 121 in the first nozzle array 120 have a larger opening area than nozzles 131 in the second nozzle array 130. In fluid communication with each nozzle array is a corresponding ink delivery pathway. Ink delivery pathway 122 is in fluid communication with nozzle array 120, and ink delivery pathway 132 is in fluid communication with nozzle array 130. Portions of fluid delivery pathways 122 and 132 are shown in FIG. 1 as openings through printhead die substrate 111. One or more printhead die 110 is included in inkjet printhead 100, but only one printhead die 110 is shown in FIG. 1. The printhead die are arranged on a support member as discussed below relative to FIG. 2. In FIG. 1, first ink source 18 supplies ink to first nozzle array 120 via ink delivery pathway 122, and second ink source 19 supplies ink to second nozzle array 130 via ink delivery pathway 132. Although distinct ink sources 18 and 19 are shown, in some applications it may be beneficial to have a single ink source supplying ink to nozzle arrays 120 and 130 via ink delivery pathways 122 and 132, respectively. Also, in some embodiments, fewer than two or more than two nozzle arrays may be included on printhead die 110. In some embodiments, all nozzles on a printhead die 110 may be the same size, rather than having multiple sized nozzles on a printhead die.

Not shown in FIG. 1 are the drop forming mechanisms associated with the nozzles. Drop forming mechanisms can be of a variety of types, some of which include a heating element to vaporize a portion of ink and thereby cause ejection of a droplet, or a piezoelectric transducer to constrict the volume of a fluid chamber and thereby cause ejection, or an actuator which is made to move (for example, by heating a bilayer element) and thereby cause ejection. In any case, electrical pulses from pulse source 16 are sent to the various drop ejectors according to the desired deposition pattern. In the example of FIG. 1, droplets 181 ejected from nozzle array 120 are larger than droplets 182 ejected from nozzle array 130, due to the larger nozzle opening area. Typically other aspects of the drop forming mechanisms (not shown) associated respectively with nozzle arrays 120 and 130 are also sized differently in order to optimize the drop ejection process for the different sized drops. During operation, droplets of ink are deposited on a recording medium 20.

FIG. 2 shows a perspective view of a portion of a printhead chassis 250, which is an example of an inkjet printhead 100 (see FIG. 1). Printhead chassis 250 includes three printhead die 251 (similar to printhead die 110 (see FIG. 1)), each printhead die containing two nozzle arrays 253, so that printhead chassis 250 contains six nozzle arrays 253 altogether. The six nozzle arrays 253 in this example may be each connected to separate ink sources (not shown in FIG. 2), such as cyan, magenta, yellow, text black, photo black, and a colorless protective printing fluid. Each of the six nozzle arrays 253 is disposed along direction 254, and the length of each nozzle array along direction 254 is 1ₙ, which is typically on the order of 1 inch or less. Typical lengths L of recording media are 6 inches for photographic prints (4 inches by 6 inches), or 11 inches for 8.5 by 11 inch paper. Thus, in order to print the full image, a number of swaths are successively printed while moving printhead chassis 250 across the recording medium. Following the printing of a swath, the recording medium is advanced. The advance distance for single pass printing would be approximately 1ₙ. For N-pass multipass printing, the advance distance for the recording medium would be approximately 1ₙ/N. The total number of passes to print a sheet of recording media is thus approximately equal to NL/1ₙ. While a larger number N usually provides better print quality, it also requires more total passes, so that printing throughput is reduced. To provide excellent print quality at fast throughput, it is desirable to identify printing conditions where N may be reduced and still provide sufficiently good print quality.

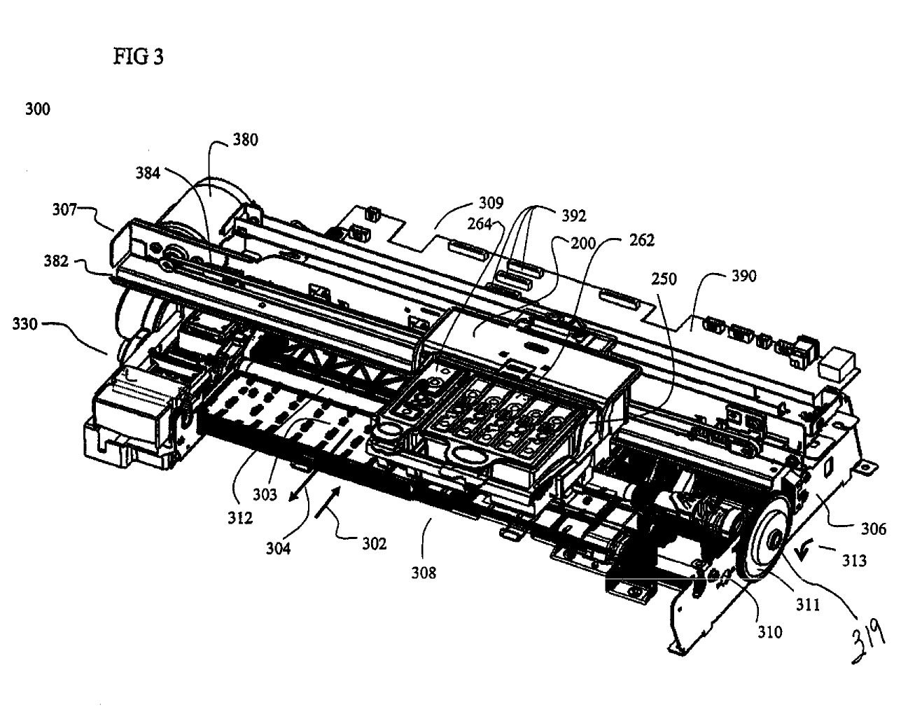

Also shown in FIG. 2 is a flex circuit 257 to which the printhead die 251 are electrically interconnected, for example by wire bonding or TAB bonding. The interconnections are covered by an encapsulant 256 to protect them. Flex circuit 257 bends around the side of printhead chassis 250 and connects to connector board 258. When printhead chassis 250 is mounted into the carriage 200 (see FIG. 3), connector board 258 is electrically connected to a connector (not shown) on the carriage 200, so that electrical signals may be transmitted to the printhead die 251.

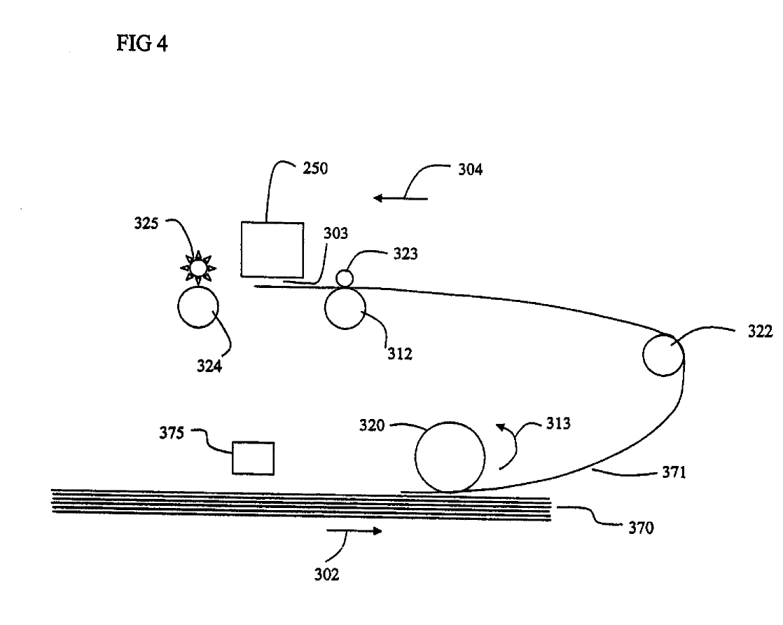

FIG. 3 illustrates a portion of a carriage printer. Some of the parts of the printer have been hidden in the view illustrated in FIG. 3 so that other parts may be more clearly seen. Printer chassis 300 has a print region 303 across which carriage 200 is moved back and forth between the right side 306 and the left side 307 of printer chassis 300 while printing. Carriage motor 380 moves belt 384 to move carriage 200 back and forth along carriage guide rail 382. Printhead chassis 250 is mounted in carriage 200, and ink supplies 262 and 264 are mounted in the printhead chassis 250. The mounting orientation of printhead chassis 250 is rotated relative to the view in FIG. 2, so that the printhead die 251 are located at the bottom side of printhead chassis 250. In this printhead chassis 250 orientation, the droplets of ink are ejected downward onto the recording media in print region 303 in the view of FIG. 3. Ink supply 262, in this example, contain; five ink sources cyan, magenta, yellow, photo black, and colorless protective fluid, while ink supply 264 contains the ink source for text black. Paper, or other recording media (sometimes generically referred to as paper herein) is loaded along paper load entry direction 302 toward the front 308 of printer chassis 300. A variety of rollers are used to advance the medium through the printer, as shown schematically in the side view of FIG. 4. In this example, a pickup roller 320 moves the top sheet 371 of a stack 370 of paper or other recording media in the direction of arrow 302. A turn roller 322 toward the rear 309 of the printer chassis 300 acts to move the paper around a C-shaped path (in cooperation with a curved rear wall surface) so that the paper continues to advance along direction arrow 304 from the rear 309 of the printer. The paper is then moved by feed roller 312 and idler roller(s) 323 to advance across print region 303, and from there to a discharge roller 324 and star wheel(s) 325 so that printed paper exits along direction 304. Feed roller 312 includes a feed roller shaft 319 along its axis, and feed roller gear 311 is mounted on the feed roller shaft 319. Feed roller 312 may consist of a separate roller mounted on feed roller shaft 319, or may consist of a thin high friction coating on feed roller shaft 319. The motor that powers the paper advance rollers is not shown in FIG. 3, but the hole 310 at the right side 306 of the printer chassis 300 is where the motor gear (not shown) protrudes through in order to engage feed roller gear 311, as well as the gear for the discharge roller (not shown). For normal paper pick-up and feeding, it is desired that all rollers rotate in forward direction 313. Toward the left side 307 in the example of FIG. 3 is the maintenance station 330. Toward the rear 309 of the printer in this example is located the electronics board 390, which contains cable connectors 392 for communicating via cables (not shown) to the printhead carriage 200 and from there to the printhead. Also on the electronics board are typically mounted motor controllers for the carriage motor 380 and for the paper advance motor, a processor and/or other control electronics for controlling the printing process, and an optional connector for a cable to a host computer.

Also shown in FIG. 4 is backside media sensor 375, which is used to detect media identification markings on the backside of the top sheet of media 371 prior to printing. The backside of the media is defined as the side of the sheet which is not intended for printing. Specialty media having glossy, luster, or matte finishes (for example) for different quality media may be marked on the backside by the media manufacturer to identify the media type. While the backside media sensor 375 is shown in FIG. 4 as being located upstream of pickup roller 320, other locations are possible. Typically the backside media sensor 375 consists of a light source (LED) and a photosensor. Light emitted from the LED is reflected from the backside of the top sheet 371 of media and is detected by the photosensor as the media moves past the sensor 375. The light signal reflected from the manufacturer's marking is different from the light signal on the rest of the backside of the media, so that different spacings of identification bars (for example) may be detected as different spacings of peaks or valleys of optical reflectance.

The ink compositions known in the art of inkjet printing may be aqueous- or solvent-based, and in a liquid, solid or gel state at room temperature and pressure. Aqueous-based ink compositions are preferred because they are more environmentally friendly as compared to solvent-based inks, plus most printheads are designed for use with aqueous-based inks.

The ink composition may be colored with pigments, dyes, polymeric dyes, loaded-dye/latex particles, or any other types of colorants, or combinations thereof. Pigment-based ink compositions are used because such inks render printed images giving comparable optical densities with better resistance to light and ozone as compared to printed images made from other types of colorants. The colorant in the ink composition may be yellow, magenta, cyan, black, gray, red, violet, blue, green, orange, brown, etc.

A challenge for inkjet printing is the stability and durability of the image created on the various types of ink jet receivers. It is generally known that inks employing pigments as ink colorants provide superior image stability relative to dye based inks for light fade and fade due to environmental pollutants especially when printed on microporous photoglossy receivers. For good physical durability (for example abrasion resistance) pigment based inks can be improved by addition of a binder polymer in the ink composition.

Ink compositions useful in the present invention are aqueous-based. By aqueous-based, it is meant that the majority of the liquid components in the ink composition are water, preferably greater than 50% water and more preferably greater than 60% water.

The water compositions useful in the invention may also include humectants and/or co-solvents in order to prevent the ink composition from drying out or crusting in the nozzles of the printhead, aid solubility of the components in the ink composition, or facilitate penetration of the ink composition into the image-recording element after printing. Representative examples of humectants and co-solvents used in aqueous-based ink compositions include (1) alcohols, such as methyl alcohol, ethyl alcohol, n-propyl alcohol, isopropyl alcohol, n-butyl alcohol, sec-butyl alcohol, t-butyl alcohol, iso-butyl alcohol, furfuryl alcohol, and tetrahydrofurfuryl alcohol; (2) polyhydric alcohols, such as ethylene glycol, diethylene glycol, triethylene glycol, tetraethylene glycol, propylene glycol, polyethylene glycol, polypropylene glycol, 1,2-propane diol, 1,3-propane diol, 1,2-butane diol, 1,3-butane diol, 1,4-butane diol, 1,2-pentane diol, 1,5-pentanediol, 1,2-hexanediol, 1,6-hexane diol, 2-methyl-2,4-pentanediol, 1,2-heptane diol, 1,7-hexane diol, 2-ethyl-1,3-hexane diol, 1,2-octane diol, 2,2,4-trimethyl-1,3-pentane diol, 1,8-octane diol, glycerol, 1,2,6-hexanetriol, 2-ethyl-2-hydroxymethyl-propane diol, saccharides and sugar alcohols and thioglycol; (3) lower mono- and di-alkyl ethers derived from the polyhydric alcohols; such as, ethylene glycol monomethyl ether, ethylene glycol monobutyl ether, ethylene glycol monoethyl ether acetate, diethylene glycol monomethyl ether, and diethylene glycol monobutyl ether acetate (4) nitrogen-containing compounds such as urea, 2-pyrrolidone, N-methyl-2-pyrrolidone, and 1,3-dimethyl-2-imidazolidinone; and (5) sulfur-containing compounds such as 2,2′-thiodiethanol, dimethyl sulfoxide and tetramethylene sulfone.

The ink compositions useful in the invention are pigment-based because such inks render printed images having higher optical densities and better resistance to light and ozone as compared to printed images made from other types of colorants. Pigments that may be used in the inks useful in the invention include those disclosed in, for example, U.S. Pat. Nos. 5,026,427; 5,086,698; 5,141,556; 5,160,370; and 5,169,436. The exact choice of pigments will depend upon the specific application and performance requirements such as color reproduction and image stability.

Pigments suitable for use in the invention include, but are not limited to, azo pigments, monoazo pigments, disazo pigments, azo pigment lakes, b-Naphthol pigments, Naphthol AS pigments, benzimidazolone pigments, disazo condensation pigments, metal complex pigments, isoindolinone and isoindoline pigments, polycyclic pigments, phthalocyanine pigments, quinacridone pigments, perylene and perinone pigments, thioindigo pigments, anthrapyrimidone pigments, flavanthrone pigments, anthanthrone pigments, dioxazine pigments, triarylcarbonium pigments, quinophthalone pigments, diketopyrrolo pyrrole pigments, titanium oxide, iron oxide, and carbon black.

Typical examples of pigments that may be used include Color Index (C. I.) Pigment Yellow 1, 2, 3, 5, 6, 10, 12, 13, 14, 16, 17, 62, 65, 73, 74, 75, 81, 83, 87, 90, 93, 94, 95, 97, 98, 99, 100, 101, 104, 106, 108, 109, 110, 111, 113, 114, 116, 117, 120, 121, 123, 124, 126, 127, 128, 129, 130, 133, 136, 138, 139, 147, 148, 150, 151, 152, 153, 154, 155, 165, 166, 167, 168, 169, 170, 171, 172, 173, 174, 175, 176, 177, 179, 180, 181, 182, 183, 184, 185, 187, 188, 190, 191, 192, 193, 194; C. I. Pigment Red 1, 2, 3, 4, 5, 6, 7, 8, 9, 10, 11, 12, 13, 14, 15, 16, 17, 18, 21, 22, 23, 31, 32, 38, 48:1, 48:2, 48:3, 48:4, 49:1, 49:2, 49:3, 50:1, 51, 52:1, 52:2, 53:1, 57:1, 60:1, 63:1, 66, 67, 68, 81, 95, 112, 114, 119, 122, 136, 144, 146, 147, 148, 149, 150, 151, 164, 166, 168, 169, 170, 171, 172, 175, 176, 177, 178, 179, 181, 184, 185, 187, 188, 190, 192, 194, 200, 202, 204, 206, 207, 210, 211, 212, 213, 214, 216, 220, 222, 237, 238, 239, 240, 242, 243, 245, 247, 248, 251, 252, 253, 254, 255, 256, 258, 261, 264; C.I. Pigment Blue 1, 2, 9, 10, 14, 15:1, 15:2, 15:3, 15:4, 15:6, 15, 16, 18, 19, 24:1, 25, 56, 60, 61, 62, 63, 64, 66, bridged aluminum phthalocyanine pigments; C.I. Pigment Black 1, 7, 20, 31, 32; C.I. Pigment Orange 1, 2, 5, 6, 13, 15, 16, 17, 17:1, 19, 22, 24, 31, 34, 36, 38, 40, 43, 44, 46, 48, 49, 51, 59, 60, 61, 62, 64, 65, 66, 67, 68, 69; C.I. Pigment Green 1, 2, 4, 7, 8, 10, 36, 45; C.I. Pigment Violet 1, 2, 3, 5:1, 13, 19, 23, 25, 27, 29, 31, 32, 37, 39, 42, 44, 50, and mixtures thereof.

Self-dispersing pigments that are dispersible without the use of a dispersant or surfactant may also be useful in the invention. Pigments of this type are those that have been subjected to a surface treatment such as oxidation/reduction, acid/base treatment, or functionalization through coupling chemistry, such that a separate dispersant is not necessary. The surface treatment can render the surface of the pigment with anionic, cationic or non-ionic groups. See for example, U.S. Pat. Nos. 6,494,943 B1 and 5,837,045. Examples of self-dispersing type pigments include Cab-O-Jet 200® and Cab-O-Jet 300® (Cabot Specialty Chemicals, Inc.) and Bonjet CW-1®, CW-2° and CW-3® (Orient Chemical Industries, Ltd.). In particular, a self-dispersing carbon black pigment ink may be employed in the ink set useful in the invention, wherein ink comprises a water soluble polymer containing acid groups neutralized by an inorganic base, and the carbon black pigment comprises greater than 1 weight % volatile surface functional groups as disclosed in commonly assigned, copending U.S. Appl. No. 60/892,137, the disclosure of which is incorporated by reference herein.

Pigment-based ink compositions useful in the invention may be prepared by any method known in the art of inkjet printing. Useful methods commonly involve two steps: (a) a dispersing or milling step to break up the pigments to primary particles, where primary particle is defined as the smallest identifiable subdivision in a particulate system, and (b) a dilution step in which the pigment dispersion from step (a) is diluted with the remaining ink components to give a working strength ink.

The milling step (a) is carried out using any type of grinding mill such as a media mill, a ball mill, a two-roll mill, a three-roll mill, a bead mill, and air-jet mill, an attritor, or a liquid interaction chamber. In the milling step (a), pigments are optionally suspended in a medium that is typically the same as or similar to the medium used to dilute the pigment dispersion in step (b). Inert milling media are optionally present in the milling step (a) in order to facilitate break up of the pigments to primary particles. Inert milling media include such materials as polymeric beads, glasses, ceramics, metals and plastics as described, for example, in U.S. Pat. No. 5,891,231. Milling media are removed from either the pigment dispersion obtained in step (a) or from the ink composition obtained in step r).

A dispersant is optionally present in the milling step (a) in order to facilitate break up of the pigments into primary particles. For the pigment dispersion obtained in step (a) or the ink composition obtained in step (b), a dispersant is optionally present in order to maintain particle stability and prevent settling. Dispersants suitable for use in the invention include, but are not limited to, those commonly used in the art of inkjet printing. For aqueous pigment-based ink compositions, useful dispersants include anionic, cationic or nonionic surfactants such as sodium dodecylsulfate, or potassium or sodium oleylmethyltaurate as described in, for example, U.S. Pat. Nos. 5,679,138; 5,651,813 or 5,985,017.

Polymeric dispersants are also known and useful in aqueous pigment-based ink compositions. Polymeric dispersants may be added to the pigment dispersion prior to, or during the milling step (a), and include polymers such as homopolymers and copolymers; anionic, cationic or nonionic polymers; or random, block, branched or graft polymers. Polymeric dispersants useful in the milling operation include random and block copolymers having hydrophilic and hydrophobic portions; see for example, U.S. Pat. Nos. 4,597,794; 5,085,698; 5,519,085; 5,272,201; 5,172,133; or 6,043,297; and graft copolymers; see for example, U.S. Pat. Nos. 5,231,131; 6,087,416; 5,719,204; or 5,714,538.

Composite colorant particles having a colorant phase and a polymer phase are also useful in aqueous pigment-based inks useful in the invention. Composite colorant particles are formed by polymerizing monomers in the presence of pigments; see for example, U.S. Pat. Appl. Publ. Nos. 2003/0199614, 2003/0203988, or 2004/0127639. Microencapsulated-type pigment particles are also useful and consist of pigment particles coated with a resin film; see for example U.S. Pat. No. 6,074,467.

The pigments used in the ink composition useful in the invention may be present in any effective amount, generally from 0.1 to 10% by weight, and preferably from 0.5 to 6% by weight.

Ink jet ink compositions may also contain non-colored particles such as inorganic particles or polymeric particles. The use of such particulate addenda has increased over the past several years, especially in ink jet ink compositions intended for photographic-quality imaging. For example, U.S. Pat. No. 5,925,178 describes the use of inorganic particles in pigment-based inks in order to improve optical density and rub resistance of the pigment particles on the image-recording element. In another example, U.S. Pat. No. 6,508,548 B2 describes the use of a water-dispersible polymeric latex in dye-based inks in order to improve light and ozone resistance of the printed images.

The ink composition may contain non-colored particles such as inorganic or polymeric particles in order to improve gloss differential, light and/or ozone resistance, waterfastness, rub resistance and various other properties of a printed image; see for example, U.S. Pat. No. 6,598,967 B1 or U.S. Pat. No. 6,508,548 B2. Colorless ink compositions that contain non-colored particles and no colorant may also be used. For example U.S. Pat. Appl. Publ. No. 2006/0100307A1 describes an ink jet ink comprising an aqueous medium and microgel particles. Colorless ink compositions are often used in the art as “fixers” or insolubilizing fluids that are printed under, over, or with colored ink compositions in order to reduce bleed between colors and waterfastness on plain paper; see for example, U.S. Pat. No. 5,866,638 or 6,450,632 B1. Colorless inks are also used to provide an overcoat to a printed image, usually in order to improve scratch resistance and waterfastness; see for example, U.S. Pat. Appl. Publ. No. 2003/0009547 A1 or E.P. 1,022,151 A1. Colorless inks are also used to reduce gloss differential in a printed image; see for example, U.S. Pat. No. 6,604,819 B2; or U.S. Pat. Appl. Publ. Nos. 2003/0085974 A1; 2003/0193553 A1; or 2003/0189626 A1.

Examples of inorganic particles useful in inks used in the invention include, but are not limited to, alumina, boehmite, clay, calcium carbonate, titanium dioxide, calcined clay, aluminosilicates, silica, or barium sulfate.

For aqueous-based inks, polymeric binders useful in the invention include water-dispersible polymers generally classified as either addition polymers or condensation polymers, both of which are well-known to those skilled in the art of polymer chemistry. Examples of polymer classes include acrylics, styrenics, polyethylenes, polypropylenes, polyesters, polyamides, polyurethanes, polyureas, polyethers, polycarbonates, polyacid anhydrides, and copolymers consisting of combinations thereof. Such polymer particles can be ionomeric, film-forming, non-film-forming, fusible, or heavily cross-inked and can have a wide range of molecular weights and glass transition temperatures.

Examples of useful polymeric binders include styrene-acrylic copolymers sold under the trade names Joncryl® (S.C. Johnson Co.), Ucar™ (Dow Chemical Co.), Jonrez® (MeadWestvaco Corp.), and Vancryl® (Air Products and Chemicals, Inc.); sulfonated polyesters sold under the trade name Eastman AQ® (Eastman Chemical Co.); polyethylene or polypropylene resin emulsions and polyurethanes (such as the Witcobonds® from Witco). These polymers are preferred because they are compatible in typical aqueous-based ink compositions, and because they render printed images that are highly durable towards physical abrasion, light and ozone.

The non-colored particles and binders useful in the ink composition used in the invention may be present in any effective amount, generally from 0.01 to 20% by weight, and preferably from 0.01 to 6% by weight. The exact choice of materials will depend upon the specific application and performance requirements of the printed image.

Ink compositions may also contain water-soluble polymer binders. The water-soluble polymers useful in the ink composition are differentiated from polymer particles in that they are soluble in the water phase or combined water/water-soluble solvent phase of the ink. The term “water-soluble” herein means that when the polymer is dissolved in water and when the polymer is at least partially neutralized the resultant solution is visually clear. Included in this class of polymers are nonionic, anionic, amphoteric and cationic polymers. Representative examples of water soluble polymers include, polyvinyl alcohols, polyvinyl acetates, polyvinyl pyrrolidones, carboxy methyl cellulose, polyethyloxazolines, polyethyleneimines, polyamides and alkali soluble resins; polyurethanes (such as those found in U.S. Pat. No. 6,268,101), polyacrylic type polymers such as polyacrylic acid and styrene-acrylic methacrylic acid copolymers (such as; as Joncryl® 70 from S.C. Johnson Co., TruDot™ IJ-4655 from MeadWestvaco Corp., and Vancryl® 68S from Air Products and Chemicals, Inc.

Examples of water-soluble acrylic type polymeric additives and water dispersible polycarbonate-type or polyether-type polyurethanes which may be used in the inks of the ink sets useful in the invention are described in copending, commonly assigned U.S. Appl. Nos. 60/892,158 and 60/892,171, the disclosures of which are incorporated by reference herein. Polymeric binder additives useful in the inks used in the invention are also described in for example US Pat. Appl. Publ. Nos. 2006/0100307A1 and 2006/0100308A1.

In practice, ink static and dynamic surface tensions are controlled so that inks of an ink set can provide prints with the desired inter-color bleed. In particular, it has been found that the dynamic surface tension at 10 milliseconds surface age for all inks of the ink set comprising cyan, magenta, yellow, and black pigment-based inks and a colorless protective ink should be greater than or equal to 35 mN/m, while the static surface tensions of the yellow ink and of the colorless protective ink should be at least 2.0 mN/m lower than the static surface tensions of the cyan, magenta and black inks of the ink set, and the static surface tension of the colorless protective ink should be at least 1.0 mN/m lower than the static surface tension of the yellow ink, in order to provide acceptable performance for inter-color bleed on both microporous photoglossy and plain paper. It is generally preferred that the static surface tension of the yellow ink is at least 2.0 mN/m lower than all other inks of the ink set excluding the clear protective ink, and the static surface tension of the clear protective ink is at least 2.0 mN/m lower than all other inks of the ink set excluding the yellow ink.

Surfactants may be added to adjust the surface tension of the inks to appropriate levels. The surfactants may be anionic, cationic, amphoteric or nonionic and used at levels of 0.01 to 5% of the ink composition. Examples of suitable nonionic surfactants include, linear or secondary alcohol ethoxylates (such as the Tergitol® 15-S and Tergitol® TMN series available from Union Carbide and the Brij® series from Uniquema), ethoxylated alkyl phenols (such as the Triton® series from Union Carbide), fluoro surfactants (such as the ZonylsÒ from DuPont; and the FluoradsÒ from 3M), fatty acid ethoxylates, fatty amide ethoxylates, ethoxylated and propoxylated block copolymers (such as the Pluronic® and Tetronic® series from BASF, ethoxylated and propoxylated silicone based surfactants (such as the Silwet® series from CK Witco), alkyl polyglycosides (such as the Glucopons® from Cognis) and acetylenic polyethylene oxide surfactants (such as the Surfynols from Air Products).

Examples of anionic surfactants include; carboxylated (such as ether carboxylates and sulfosuccinates), sulfated (such as sodium dodecyl sulfate), sulfonated (such as dodecyl benzene sulfonate, alpha olefin sulfonates, alkyl diphenyl oxide disulfonates, fatty acid taurates and alkyl naphthalene sulfonates), phosphated (such as phosphated esters of alkyl and aryl alcohols, including the Strodex® series from Dexter Chemical), phosphonated and amine oxide surfactants and anionic fluorinated surfactants. Examples of amphoteric surfactants include; betaines, sultaines, and aminopropionates. Examples of cationic surfactants include; quaternary ammonium compounds, cationic amine oxides, ethoxylated fatty amines and imidazoline surfactants. Additional examples are of the above surfactants are described in “McCutcheon's Emulsifiers and Detergents: 2003, North American Edition”.

A biocide may be added to an ink jet ink composition to suppress the growth of micro-organisms such as molds, fungi, etc. in aqueous inks. A preferred biocide for an ink composition is Proxel® GXL (Zeneca Specialties Co.) at a final concentration of 0.0001-0.5 wt. %. Additional additives which may optionally be present in an ink jet ink composition include thickeners, conductivity enhancing agents, anti-kogation agents, drying agents, waterfast agents, dye solubilizers, chelating agents, binders, light stabilizers, viscosifiers, buffering agents, anti-mold agents, anti-curl agents, stabilizers and defoamers.

The pH of the aqueous ink compositions useful in the invention may be adjusted by the addition of organic or inorganic acids or bases. Useful inks may have a preferred pH of from about 2 to 10, depending upon the type of dye or pigment being used. Typical inorganic acids include hydrochloric, phosphoric and sulfuric acids. Typical organic acids include methanesulfonic, acetic and lactic acids. Typical inorganic bases include alkali metal hydroxides and carbonates. Typical organic bases include ammonia, triethanolamine and tetramethylethylenediamine.

The exact choice of ink components will depend upon the specific application and performance requirements of the printhead from which they are jetted. Thermal and piezoelectric drop-on-demand printheads and continuous printheads each require ink compositions with a different set of physical properties in order to achieve reliable and accurate jetting of the ink; as is well known in the art of inkjet printing. Acceptable viscosities are no greater than 20 cP, and preferably in the range of about 1.0 to 6.0 cP.

For color inkjet printing, a minimum of cyan, magenta and yellow inks are required for an inkjet ink set which is intended to function as a subtractive color system. Very often black ink is added to the ink set to decrease the ink required to render dark areas in an image and for printing of black and white documents such as text. The need to print on both microporous photoglossy and plain paper receivers can make desirable a plurality of black inks in an ink set. In this case, one of the black inks may be better suited to printing on microporous photoglossy receivers while another black ink may be better suited to printing on plain paper. Use of separate black ink formulations for this purpose can be justified based on desired print densities, printed gloss, and smudge resistance for the type of receiver.

Other inks can be added to the ink set. These inks include light or dilute cyan, light or dilute magenta, light or dilute black, red, blue, green, orange, gray, and the like. Additional inks can be beneficial for image quality but they add system complexity and cost. Finally, colorless ink composition can be added to the ink jet ink set for the purpose of providing gloss uniformity, durability and stain resistance to areas in the printed image which receive little or no ink otherwise. Even for image areas printed with a significant level of colorant containing inks, the colorless ink composition can be added to those areas with further benefits. An example of a protective ink for the above purposes is described in US Pat. Appl. Publ. Nos. 2006/0100306A1 and 2006/0100308A1.

The inkjet receiver useful in the invention comprises an ink-receiving pack coated on a support. The ink-receiving pack comprises one or more image-receiving layers (typically one image-receiving layer) and further layers which are involved in the ink-receiving process, such as those intended to absorb the carrier fluid of the ink or provide capacity (i.e. a sump) or to increase the draw or rate of uptake of ink on the surface of the receiver. Typically, the ink-receiving pack comprises the image-receiving layer(s) and the liquid absorbing layers and any intermediate layers. For use in the present invention, the ink-receiving pack comprises at least a first, image-receiving, layer, a second layer and optionally a third layer.

The first, image-receiving, layer comprises inorganic particulate material in a dry weight amount of from 0.5 to 10 g/m², selected from alumina, silica, or titania. The alumina may be one or more forms of alumina, such as, for example, porous alumina, amorphous alumina, boehmite (such as a pseudo-boehmite), alumina hydrate particles, alumina hydrate surface-coated particles (e.g. alumina hydrate surface coated silica particles) or fumed alumina. Preferably, the alumina is fumed alumina. Specific examples of fumed alumina useful in the inkjet receiver described herein include those available from Cabot Corporation under the trade name CAB-O-SPERSE™ PG003 or PG008.

Optionally, in the first layer, one or more colloidal metallic oxide particulate materials may be employed, such as colloidal alumina, colloidal silica, and blends thereof.

The surfaces of the metallic oxides may be treated to adjust surface charge for compatibility with other materials, such as cationic mordants.

The first, image-receiving, layer also comprises a binder. The binder may be present in an amount of from 0.5 to 25% by dry weight of the first layer, preferably from 0.5 to 10%, more preferably from 1 to 5% and still more preferably from 1.5 to 3%.

The binder may be any suitable material for binding the particular inorganic particles in an inkjet receiver layer. Suitable such binders may be selected, for example, from one or more of naturally occurring hydrophilic colloids and gums such as gelatin, albumin, guar, xantham, acacia and chitosan and their derivatives, functionalised proteins, functionalised gums and starches, cellulose ethers and their derivatives, such as hydroxyethyl cellulose, hydroxypropyl cellulose and carboxymethyl cellulose, latex polymers such as styrene butadiene latex and styrene acrylate latex, polyvinyl oxazoline and polyvinyl methyloxazoline, polyoxides, polyethers, poly(ethylene imine), poly(acrylic acid), poly(methacrylic acid), n-vinyl amides including polyacrylamide and polyvinyl pyrrolidone, polyethylene oxide and polyvinyl alcohol, its derivatives and copolymers. Preferably, the binder is a polyvinyl alcohol.

Optionally, the first, image-receiving, layer comprises a mordant material such that the inkjet receiver is capable of delivering good printing and imaging performance regardless of whether printing is carried out with a dye-based ink or a pigment-based ink, i.e. the inkjet receiver is a universal receiver. Preferably, the image-receiving layer comprises a mordant material in a dry weight ratio to the first inorganic particulate material of from 10:90 to 30:70. Preferably, the mordant is present in an amount of from 0.2 to 1.5 g/m².

The mordant may be any suitable mordant and may be any one or more of, for example, a cationic polymer, e.g. a polymeric quaternary ammonium compound, or a basic polymer, such as poly(dimethylaminoethyl)methacrylate, polyalkylenepolyamines, and products of the condensation thereof with dicyanodiamide, amine-epichlorohydrin polycondensates, divalent Group II metal ions, lecithin and phospholipid compounds or any suitable mordant that is capable of assisting with fixing a dye material transferred to it. Examples of such mordants include vinylbenzyl trimethyl ammonium chloride/ethylene glycol dimethacrylate, poly(diallyl dimethyl ammonium chloride), poly(2-N,N,N-tri-methylammonium)ethyl methacrylate methosulfate, poly(3-N,N,N-trimethyl-ammonium)propyl chloride. A preferred mordant is a quaternary ammonium compound, such as, for example, a polymer of (m and p chloromethyl)ethenyl-benzene and 2-methyl-2-propenoic acid 1,2-ethanediylester, quaternized with N,N-dimethylmethanamine.

The first layer may also include a surfactant, added, for example, to improve the coatability of the coating composition. Suitable surfactants, depending upon the coating method used, include fluorosurfactants such as Lodyne® S100 or Zonyl® FSN, or a non-fluoro surfactants such as Olin® 10G.

The second layer comprises one or more inorganic particulate materials in a total dry weight amount of from 10 to 70 g/m². The inorganic particulate materials may be selected from fumed or colloidal metal oxides. Examples of the oxides include alumina, silica and titania.

The binder in the second layer may be any suitable binder and may be selected from one or more of those listed in respect of the first layer, but is preferably polyvinyl alcohol. Binder may be present in the second layer in an amount suitable to bind the inorganic particles in an intermediate layer of an ink-jet receiver. Preferably, however, the binder in the second layer is present in an amount of from 2 to 20% by dry weight of the second layer.

Optionally, surfactants similar to those referred to above may be added to the second layer to aid coating.

As mentioned above, the ink-receiving pack of the inkjet receiver preferably has a third layer which comprises inorganic particulate material or mixture of inorganic particulate materials in a dry weight amount of from 10 to 40 g/m². The inorganic particulate material may be selected, for example, from one or more of silica (e.g. colloidal silica, synthetic amorphous silica, fumed silica or silica gel), alumina (e.g. alumina sols, colloidal alumina, cationic aluminium oxide or hydrates thereof, pseudo-boehmite, etc.), surface-treated cationic colloidal silica, magnesium silicate, aluminium silicate, magnesium carbonate, kaolin, talc, calcium sulfate, barium sulfate, titanium dioxide, zinc oxide, zinc sulfide, zinc carbonate, satin white, diatomaceous earth, clays, calcium silicate, aluminium hydroxide, lithopone, zeolite(s) (such as molecular sieves 3A, 4A, 5A and 13X), hydrated hallocyte, magnesium hydroxide and calcium carbonates (ground and/or precipitated). Organic white pigment particulate materials, such as styrene plastics pigment, acrylic plastics pigment, polyethylene, microcapsules, urea resin and melamine resin, may be used instead of or in addition to the inorganic particulate material, but inorganic particulate materials are preferred. Preferred particles, for the bulk of the inorganic particles in the base layer, are structured pigments in which the dispersed particles have low or no internal porosity, as compared to microporous pigments. Structured pigments have a non-spherical morphology that does not allow dense packing in the dried coating. Precipitated calcium carbonate (PCC) is an example of a structured pigment that can provide high porosity in inkjet coatings. Preferably, the inorganic particulate materials of the optional third layer are selected from calcium carbonate, clay and amorphous silica. A moderate amount of silica gel up to 30% of the total weight of particles in the base layer may be used to increase porosity.

The binder in the third layer may be any suitable binder and may be selected from one or more of those listed above in respect of the first layer, but is preferably polyvinyl alcohol. The binder may be present in the third layer in an amount suitable to bind the inorganic particles. Preferably, the binder in the third layer is present in an amount of from 0.5 to 15% by dry weight.

As a preferred option, in order to help improve the binding in the third layer and to improve the gloss of the inkjet receiver, whilst having a minimal effect on porosity of the third layer and maintaining a liquid communication between the third and adjacent layers, the binder in the third layer comprises a mixture of non-polymer latex binder such as PVA and a polymer latex binder, such as a styrene butadiene latex. Preferably, the polymer latex binder is present in an amount similar to that of the binder, e.g. within 50% by weight of the amount of non-polymer latex binder, e.g. within 20%.

The third layer may also comprise a cross-linker in an amount of about 2% by dry weight of the third layer.

In a preferred embodiment useful with the invention, the inkjet receiver comprises a subbing layer between the support and the ink-receiving pack. The subbing layer is preferably coated onto the support prior to coating the lowest layer of the ink-receiving pack, e.g. the subbing layer may be coated in a separate pass of a coating station to that of the ink-receiving pack. The subbing layer may be adjacent to the lowest layer of the ink-receiving pack or may be separated by one or more interlayers.

The subbing layer, which improves the adhesion of the underlayer of the ink-receiving pack to the support, typically comprises a polymer material, such as sulfonated polyesters, gelatin, poly(vinyl pyrrolidone), cellulose ethers and their derivatives such as methyl cellulose, capable of improving the adhesion of the under layer of the ink-receiving pack to the support. Preferably the subbing layer comprises a boric acid, borate or derivative and/or salt thereof. Suitable boric acid, borates and derivatives and/or salts thereof include sodium borates, derivatives of boric acid, boric anhydride and the like. A particularly preferred borate is sodium tetraborate decahydrate, which is available from Borax Limited under the trade name Borax® Decahydrate. The total dry laydown of material in the subbing layer is preferably in the range 0.5 to 3 g/m². Optional additional components for inclusion in the subbing layer include surfactants, for facilitating coating of the subbing layer onto the support.

An inkjet receiver useful in the present invention may be manufactured by coating the ink-receiving pack and any optional further layers, such as the subbing layer onto the support by any suitable process known in the art. In order to improve the adhesion of the ink-receiving pack and optional further layers to the support, the surface of the support may optionally be subjected to a corona discharge treatment prior to applying the coatings.

The coating compositions, which may be aqueous- or solvent-based dispersions but are preferably aqueous dispersions of the components that go to make the desired layers, may be applied by any suitable technique, such as, for example, dip-coating, wound-wire rod-coating, doctor blade-coating, rod-coating, air knife-coating, gravure- and reverse-roll-coating, slide-coating, bead-coating, extrusion-coating, curtain-coating and the like. Preferably an extrusion-coating or curtain-coating technique is used and more preferably curtain coating.

In the coating process, any optional subbing layer is preferably first coated onto the support and dried and then the layers of ink-receiving pack coated simultaneously or sequentially onto the optionally coated support. Where there are two layers in the ink-receiving pack, the two layers may be coated sequentially with drying of the second layer prior to coating the first layer or may be coated simultaneously. A third or subsequent layer of the ink-receiving pack may be coated prior to the upper layers or simultaneous with the second or second and first layers.

The support may be any support, preferably a resin-coated support or a coated paper support. The support used may be of any suitable thickness, such as, for example from 50 to 500 μm, or preferably from 75 to 300 μm. Antioxidants, antistatic agents, plasticizers or other known additives may be incorporated into the support, if desired.

A preferred support is polyolefin resin-coated paper with at least one surface, on which the ink-receiving layer is provided, coated with a polyolefin resin, and polyolefin resin-coated paper, both surfaces of which are coated with the polyolefin resin, may be more preferably mentioned. A preferable formation of the polyolefin resin-coated paper is such that the average roughness at 10 points in accordance with JIS B 0601 is 0.5 μm or lower, and the 60′-specular glossiness in accordance with JIS Z 8741 is 25 to 75%. When a recording medium of a semi-gloss grade is obtained, a film or resin-coated paper, with a surface, on which the ink-receiving layer is formed, subjected to matting or embossing is preferably used.

The process of extrusion lamination may be used to produce a polyolefin resin-coated paper, and is illustrated in U.S. Pat. No. 4,875,262. In this process, a molten curtain of thermoplastic polyolefin resin is extruded onto the paper close to a nip formed by a chill roller and nip roller. The cooled chill roller solidifies the polyolefin resin and imparts its surface character to the solid polyolefin layer. A polished chill roller produces a smooth resin surface, while a textured chill roll surface produces a textured resin surface. U.S. Pat. No. 4,875,262 also describes the process for forming a textured surface on the chill roller. First the roller surface is machined and polished smooth and plated with copper. Secondly, the surface is blasted with glass beads to form indentations in the range of 10 μm-20 μm. Next the surface is blasted with particles of silicon dioxide, and finally the surface is plated with nickel. The resulting resin surface obtained with such a chill roll is termed a luster surface.

No particular limitation is imposed on the thickness of the resin-coated paper. However, the thickness is preferably 25 to 500 μm. If the thickness of the resin-coated paper is smaller than 25 μm, the stiffness, photographic feel and opacity may degrade. If the thickness of the resin-coated paper is greater than 500 μm on the other hand, the resultant recording medium may cause difficulty with paper feeding and conveyance in a printer. The thickness of the resin-coated paper is more preferably within a range of from 50 pin to 300 μm. No particular limitation is also imposed on the basis weight of the resin-coated paper. However, it is preferably within a range of from 25 g/m² to 500 g/m².

The preferred coating method for coating on a textured resin-coated support is a direct-metering method, such a bead or curtain coating, in which the amount of material coated is controlled by extrusion from a hopper. A post-metering method, such as rod coating, would tend to smooth the variations in support texture. Furthermore, the fine particles necessary to impart a glossy surface to the upper layers are difficult to concentrate sufficiently to meet the percent solids and viscosity requirements of rod coating.

As an alternative to the resin-coated support, a photo-quality inkjet receiver may employ a coated paper support, in which the base layer coating provides a smooth surface for the ink-receiving layers. In order to improve the smoothness of an inkjet receiver coated on raw paper support, the base layer preferably is coated by a self-metering method such as a rod or a blade coating technique. Preferably the coating method is a rod coating method. A base layer coated by this technique preferably is coated from a coating composition at high solids content. Fine inorganic particles such as alumina are difficult to coat at high solids. Preferred inorganic particles for a base layer coated by the self-metering coating technique include calcium carbonate, clay and silica gel or mixtures thereof.

Calendering with pressure, and optionally heat, is a useful means of increasing the gloss of a receiver employing a coated paper support. Calendering effort (number of passes, pressure and temperature) may be increased until a maximum gloss is achieved without significant loss of porosity. Overcalendering is to be avoided, as it results in a loss of porosity and consequently increased coalescence during printing. Calendering may be applied to the base layer prior to coating of the top layers, or may be applied to the completed coating or at both stages.

The surface texture of a receiver employing a coated paper support may be modified by the choice of a textured embossing roll for embossing of the base layer, intermediate layer or top surface. A smooth calender roll may be used to enhance surface gloss while preserving the underlying texture. The difference between a receiver having a luster surface and a receiver having a glossy surface is a difference of texture, not a difference in surface composition.

An example of a photo-quality inkjet receiver employing a coated paper support is described in US Pat. Appl. Publ. No. 2007/02022:78, hereby incorporated by reference.

In a particularly preferred embodiment, the inkjet recording element comprises, over an absorbent support, in order from the support, the following layers:

(a) a porous base layer comprising a polymeric binder and at least 80 percent by weight of inorganic particles, wherein at least 60% by weight of the inorganic particles comprises precipitated calcium carbonate having a particle size of 0.4 to 5 micrometers;

(b) a porous ink-receiving intermediate layer comprising at least 80 percent by weight of inorganic particles of hydrated or unhydrated alumina, the median primary particle size of which is between 150 and 250 nm, wherein the concentration of fumed alumina in the intermediate layer, if present, is less than the concentration of fumed alumina in the upper layer relative to other inorganic particles in each layer; and

(c) a porous image-receiving upper layer comprising at least 80 percent, by weight of total inorganic particles, of an admixture of finned alumina particles and aluminum oxyhydroxide particles, wherein the latter particles have a median particle size of from about 90 to 150 nm and the former particles have a median secondary particle size of under 200 nm and a primary average particle size of 7 to 40 nm.

Other additives that optionally can be included in the gloss-producing ink-receiving layers include pH-modifiers like nitric acid, cross-linkers, rheology modifiers, surfactants, UV-absorbers, biocides, lubricants, dyes, dye-fixing agents or mordants, optical brighteners, and other conventionally known additives.

Since the inkjet recording element may come in contact with other image recording articles or the drive or transport mechanisms of image-recording devices, additives such as surfactants, lubricants, matte particles and the like may be added to the inkjet recording element to the extent that they do not degrade the properties of interest.

Optional other layers, including subbing layers, overcoats, further intermediate layers between the base layer and the upper layer, etc. may be coated by conventional coating means onto a support material commonly used in this art. Preferably, the base layer and the intermediate layer are the only two layers over 5 micrometers thick.

As described above, inkjet receivers vary widely in their capacity and speed of ink absorption. In order to obtain high-quality prints, the printing system must take into account these variations and adjust the printing speed, number of passes, ink/fluid amounts and drop placement for each type of receiver. One method of matching print mode to the intended receiver is to require the user to provide the media identification to the printer through the user interface. This method may be inconvenient to the user and is prone to error by the user, who may misidentify the media to the printer. A number of automatic media detection methods have been developed to overcome these problems.

U.S. Pat. No. 6,557,965 to Walker, et al., describes a variety of media detection schemes based on measurements of the optical reflectance and transmission properties of the media. Basic categories of media, such as transparencies, matte, glossy, and plain paper surfaces, may be detected by algorithms based on such input data.

U.S. Pat. No. 7,120,272 discloses a method of detecting the type of media by detecting the periodicities in a repeating pattern printed on the backside of the receiver during manufacturing and comparing with a table of known values provided by the manufacturer. One preferred embodiment of this technique employs an infrared-absorbing indicia for the backprint coupled with infrared detection in the printer mechanism, so as to reduce the visibility of the backprint and optimize the cost and performance of the media detection system.

As is well known in the art, increasing the number of passes the print head makes over a section of the receiver is an effective way to reduce imaging artifacts. These additional passes are typically referred to as banding passes. For example, a print mode utilizing four passes of the print head will be less effective at hiding drop placement inaccuracies than, say, a print mode utilizing six banding passes. Therefore, a print mode utilizing four banding passes will demand greater accuracy of drop placement produced by the print head and printing mechanism than would be required if a six banding pass print mode were to be used.

At least some of the artifacts related to gloss can also be ameliorated with additional banding passes. For example, a glossy media that is prone to gloss artifacts may require additional banding passes to hide some gloss artifacts. The implementation of banding passes may be accomplished in a variety of ways as is taught widely in the prior art (e.g., U.S. Pat. Nos. 4,967,203; 5,992,962; and U.S. Pat. No. 5,790,150). A particularly useful means of print masking that lends itself to multi-level printing (allowing for placing more than one drop of a given ink on a single pixel) and accomplishes the goals of mitigating artifacts with banding passes is described in US Pat. Appl. Publ. No. 2007/0201054 A1 (t“the '054 Publ.”). In that teaching, binary, three-dimensional masks are used to distribute requested drops across multiple banding passes. The '054 Publ. teaches that the design of the print mask (the distribution of 0's and 1's within each of the masks planes) in combination with one or more prescribed paper advance distances is sufficient control to implement any number of banding passes.

### EXAMPLE

### Ink Preparation

Pigment dispersions for each color ink were made according to the descriptions given below.

### Cyan Pigment Dispersion:

A mixture of Pigment Blue 15:3, potassium salt of oleylmethyl taurate (KOMT) and deionized water were charged into a mixing vessel along with polymeric beads having mean diameter of 50 mm, such that the concentration of pigment was 20% and KOMT was 25% by weight based on pigment. The mixture was milled with a dispersing blade for over 20 hours and allowed to stand to remove air. Milling media were removed by filtration and the resulting pigment dispersion was diluted to approximately 10% pigment with deionized water to obtain the cyan pigment dispersion.

### Magenta Pigment Dispersion:

The process used for cyan pigment dispersion was used except Pigment Red 122 was used in place of Pigment Blue 15:3 and the KOMT level was set at 30% by weight based on the pigment.

### Yellow Pigment Dispersion:

The process used for cyan pigment dispersion was used except Pigment Yellow 155 was used in place of Pigment Blue 15:3.

### First Black Pigment Dispersion:

The process used for cyan pigment dispersion was used except Pigment Black 7 was used in place of Pigment Blue 15:3.

In addition to the pigment dispersions, polymeric binder components are added to the inks to provide desirable attributes such as image durability and gloss uniformity. Specific polymeric additives and polymeric beads added to the inks in the below examples were:

Acrylic Polymer: benzylmethacrylate/methacrylic add copolymer having an acid number of about 135 as determined by titration method, a weight average molecular weight of about 7160 and number average molecular weight of 4320 as determined by the Size Exclusion Chromatography. The polymer is neutralized with potassium hydroxide to have a degree of neutralization of about 85%.

Polyurethane Binder: polycarbonate-type polyurethane having a 76 acid number with a weight average molecular weight of 26,100 made with isophorone diisocyanate and a combination of poly(hexamethylene carbonate) diol and 2,2-bis(hydroxymethyl)proprionic acid where 100% of the acid groups are neutralized with potassium hydroxide.

Microgel particles: aqueous suspension of methyl methacrylate/divinyl benzene/methacrylic acid particles having fiftieth percentile particle size of 79 nm.

The inks were prepared by simple admixture of the components with stirring for at least one hour followed by 1.2 micron filtration. Table 1 provides relative weights of each component in the inks of the ink set. All of the pigments are added as dispersions prepared according to the description above except the Orient CW-3 carbon black pigment dispersion was used as supplied. The amount of dispersion added to the ink was adjusted to provide the weight percent of pigment shown in table 1. The amount of acrylic polymer additive, polyurethane binder additive and microgel suspension were also adjusted to provide the weight percent of polymer or microgel particles shown in table 1. The following example is provided to illustrate, but not to limit, the invention.

TABLE 1
Example Ink Set

| | Example Ink Set | | | | | |
|---|---|---|---|---|---|---|
| component | C-1 | M-1 | Y-1 | Bk1-1 | P-1 | Bk2-1 |
| pigment blue 15:3 | 2.20 | | | | | |
| pigment red 122 | | 3.00 | | | | |
| pigment yellow 155 | | | 2.75 | | | |
| pigment black 7, PB15:3, PR122 | | | | 2.50* | | |
| Orient CW-3 pigment (self-dispersed | | | | | | 4.50 |
| carbon black) | | | | | | |
| acrylic polymer | 0.90 | 0.90 | 1.50 | 0.90 | 0.80 | 0.40 |
| polyurethane binder | 1.20 | 1.20 | 1.60 | 1.20 | 2.40 | |
| microgel particles | | | | | 0.20 | |
| glycerol | 7.50 | 8.00 | 10.0 | 8.00 | 12.0 | 3.00 |
| ethylene glycol | 4.50 | 5.00 | 2.00 | 4.00 | 6.00 | |
| diethylene glycol | | | | | | 9.00 |
| polyethylene glycol 400 MW | | | | | | 3.00 |
| Strodex PK-90 (anionic phosphate ester | | | | 0.41 | | |
| surfactant) | | | | | | |
| Surfynol 465 (acetylenic non-ionic | 0.75 | 0.50 | | | | |
| surfactant) | | | | | | |
| Tergitol 15-S-5 (low HLB | | | 0.75 | | 1.00 | |
| secondary alcohol ethoxylate non- | | | | | | |
| ionic surfactant) | | | | | | |
| Tergitol 15-S-12 (mid HLB | | | | | | 0.40 |
| secondary alcohol ethoxylate non-ionic | | | | | | |
| surfactant) | | | | | | |
| Kordek MLX biocide | 0.02 | 0.02 | 0.02 | 0.02 | 0.02 | 0.02 |
| triethanolamine | 0.05 | 0.05 | | 0.05 | | |
| water | bal. | bal. | bal. | bal. | bal. | bal. |
| static surface tension mN/m | 35.8 | 36.2 | 31.4 | 33.8 | 30.2 | 34.0 |
| dynamic surf. ten. @ 10 ms. | 40.7 | 44.1 | 47.7 | 46.9 | 43.6 | 52.8 |

*1.625% PB7, 0.375% PB15:3, 0.50% PR122

The static and dynamic surface tension values reported in Table 1 were measured at approximately 25° C.

The cyan, magenta, yellow, first black, and colorless protective inks were placed in the appropriate chamber of a Kodak No. 10 five chamber color ink cartridge. The second black ink was placed in a Kodak No. 10 single chamber black ink cartridge. Each cartridge was then mounted in a Kodak model 5300 thermal ink jet printer followed by a standard ink priming step to bring ink from the cartridge through the print head ink flow channels.

### Photographic-Quality Receiver Preparation

A luster inkjet receiver L1 was prepared on a textured resin-coated (RC) paper support. The RC paper carried a backprint comprising diagonal lines of infrared absorbing ink. On the front side of the support were coated three layers in order from the support, a foundation layer, an intermediate layer and a top layer. The foundation layer composition comprised colloidal alumina particles (Catapal 200, Sasol, 140 nm particles), binder poly (vinyl alcohol) (GH-23, Gohsenol), crosslinkers glyoxal (Catabond GHF) and boric acid, and surfactants (Olin 10 G and APG 325) coated at 6.5 g solids/m². The intermediate layer comprised colloidal alumina particles (Catapal 200, Sasol, 140 nm particles), binder poly (vinyl alcohol) (GH-23, Gohsenol), crosslinkers glyoxal (Cartabond GHF) and boric acid, and surfactants (Olin 10 G and APG 325) coated at 60 g solids/m². The top layer comprised fumed alumina particles (PG-008, Cabot, 130 nm particles), binder poly (vinyl alcohol) (GH-23, Gosenol), latex dispersion of polymeric cationic mordant as described in U.S. Pat. No. 6,045,917, surfactant (Zonyl FSN), and crosslinkers glyoxal (Cartabond GHF) and boric acid at coated at 2.2 g/m². A second luster inkjet receiver L2 prepared from similar materials as receiver L1 was supplied by Felix Schoeller. A comparison glossy receiver G2 coated on a smooth RC support was manufactured using the same coating layers as L2.

Luster receiver L3 employed a base layer similar to that described in Example 1 of U.S. Pat. Application Publication. No. 2007/0202278, but the upper layers comprised layers similar to the foundation, intermediate and top layers of luster receiver L1. During manufacturing, luster receiver L3 was lightly embossed following drying of a partial coating weight, and then the remaining coating weight was applied and dried. The surface was lightly calendered with a smooth roller to increase surface gloss, but preserve the underlying texture. The resulting surface was similar in roughness to luster receivers L1 and L2 that were coated on a textured RC paper support. Glossy receiver G3 is similar to L3, except that it received no embossing and was calendered with a smooth roller. Heavily embossed receiver E3 was identical to L3 in composition, except that the intermediate embossing step employed a rougher roller in order to provide a surface significantly rougher than luster receiver L3. A sample of a matte-surface inkjet receiver M1 was included for comparison. Each of the receivers comprised a back print of diagonal lines of unique spacing, detectable by a KODAK EASYSHARE 5300 inkjet printer.

### Surface Roughness Measurements

Surface roughness measurements were conducted on unprinted samples of the media described above using a Perthen instrument light load stylus profilometer measurement. Measurements were repeated five times and the average values of roughness computed from the profiles. The root mean square (rms) roughness, Rq, is the rms (standard deviation) or “first moment” of the height distribution. The results are shown in Table 2 below.

### Print Mode Experiment and Comparison

A KODAK EASYSHARE 5300 printer was programmed with a writing system algorithm capable of receiving input from user, the backprint detector and the media detector and choosing a print mode corresponding to glossy, textured, or matte photo-quality receiver based on the media type detected. The printer was supplied with the pigment-based ink set described above and was then used to print a color test target on the examples of inkjet receivers described above. Additional prints were made with the automatic print mode: selection manually overridden for comparison purposes. When the printer selected or was directed to print in 7-pass mode, the 4″×6″ print was completed in 34 seconds, while in 5-pass mode, the 4″×6″ print was completed in 24 seconds.

The optical properties of unprinted and printed samples were evaluated. Specular reflectance (30 degrees) and average haze (15 degrees) (Haze 15 DEG) were measured for a dark printed color patch with a Tricor haze meter. The lightness, L*, of a dark printed patch was measured with a Spectrolino meter. Gloss artifacts were visually evaluated and rated on the following scale:

0—No visible artifacts
1—Just noticeable
2—Slightly visible
3—Visible, slightly objectionable

### 4—Objectionable

### 5—Severe

The results of the surface roughness, optical properties and gloss artifact evaluations are collected in Table 2.

TABLE 2

| | | | Surface | Specular | | | | |
|---|---|---|---|---|---|---|---|---|
| | | | Roughness | Reflectance | Haze | | Gloss | Gloss |
| | | | (Rq, microns) | (printed) | (15 Deg) | L* | Banding | Banding |
| Receiver | Support | Calender | (unprinted) | (30 degrees) | (printed) | (printed) | (7-Pass) | (5-Pass) |
| G2 | Smooth | None | 0.32 | 14.50 | 1.89 | 5.85 | 2.5 | 5 |
| | RC | | | | | | | |
| G3 | Coated | Smooth | 0.52 | 13.30 | 2.63 | 7.29 | 2 | 3 |
| | paper | | | | | | | |
| L1 | Textured | None | 1.74 | 5.36 | 4.75 | 6.25 | 0 | 1 |
| | RC | | | | | | | |
| L2 | Textured | None | 1.97 | 3.18 | 11.36 | 8.35 | 0 | 0.5 |
| | RC | | | | | | | |
| L3 | Coated | Light | 2.00 | 4.11 | 9.52 | 7.22 | 0 | 0.5 |
| | paper | texture | | | | | | |
| E3 | Coated | Heavy | 3.38 | 0.72 | 237.96 | 15.75 | 0 | 0 |
| | Paper | embossed | | | | | | |
| M4 | Coated | | 4.12 | 0.05 | 887.25 | 24.43 | 0 | 0 |
| | paper | | | | | | | |

The results in Table 2 show that an appreciable degree of gloss banding is present in the glossy receivers G2 and G3 when printed in a 5-pass print mode. A 7-pass print mode significantly lowers the objectionable artifacts, but at the cost of 40% additional printing time. However, for the luster papers L1, L2, and L3, the 5-pass mode provided excellent prints with barely noticeable gloss band artifacts. Note that luster receiver L2 has the same composition as glossy receiver G2, but L2 has a greater degree of texturing. Thus, it is the degree of texturing that enables excellent prints for 5-pass mode in the L2 receiver. While the heavily embossed sample E3 exhibited no gloss banding when printed with a 5-pass print mode, the haze value was unacceptably high. The matte sample M1 was free of gloss artifacts because the gloss itself was absent. Note that the printed L* is high for the matte sample indicating a lower dynamic range and a less pleasing printed image. While suitable for special applications, matte paper is not the glossy surface preferred among the general population.

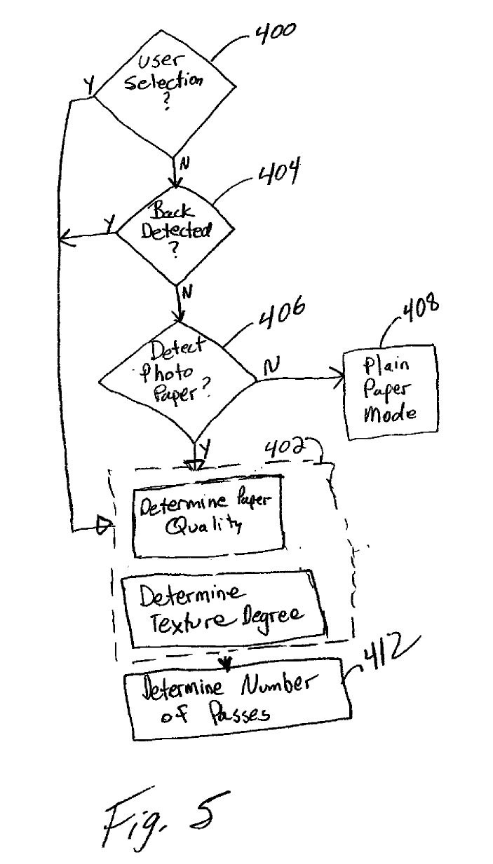

With reference to FIG. 5, a determination is made in a step 400 whether a photo selection, which is input by the user, is detected on the printer. If it is determined that a user photo selection is detected, control passes to a step 402, which is described in more detail below. Otherwise, control passes to a step 404, which determines whether the receiver medium (sheet) in the printer includes a back marking detected by the printer. If the back marking is detected, control passes to the step 402. Otherwise, control passes to a step 406 for determining whether the receiver medium is detected as photo paper by illuminating an area of the receiver medium and measuring reflectivity. If photo paper is not detected in the step 406, control passes to step 408 for setting the paper mode to plain paper. If, on the other hand, photo paper is detected in the step 406, control passes to the step 402.

In the step 402, the photo paper quality (e.g., high, medium, or economy) and the degree of texture are determined in accordance with the results of steps 400, 404 or 406. In a step 412, a number of printhead passes over the paper is determined as a function of the photo paper quality and degree of texture. Luster receiver herein is defined as a receiver having a surface roughness (RMS) within a range of 1.0-2.5 microns. Glossy receiver herein is defined as a receiver having a surface roughness (RMS) less than 1 micron. Therefore, the desired surface roughness of a luster receiver allows faster print speeds relative to a glossy receiver, while retaining excellent print quality. For example, high quality paper that is glossy (i.e., not textured) receives 7 printhead passes while high quality paper having a texture within a preferred range (i.e., luster paper) receives 5 printhead passes. The preferred range of the texture Rq is between 1.0-2.5 microns (see Table 2). In general, the preferred range of texture enables excellent quality printing with fewer printhead passes. It is noted that any one of steps 400, 404 and 406 can be used to detect the photo paper quality and degree of texturing. However, other methods of detecting photo paper quality and the degree of texturing can be utilized within the context of the present invention.

The speed at which an image is printed is a function of the number of printhead passes. More specifically, a fewer number of printhead passes typically results in an image that is printed faster. In one embodiment of the invention, a 4″×6″ image is printed on a luster photo paper in less than or equal to 30 seconds (i.e., 5 cm²/sec).

The invention has been described in detail with particular reference to certain preferred embodiments thereof, but it will be understood that variations and modifications can be effected within the spirit and scope of the invention.

1. A method of printing, the method comprising:
providing a carriage-type inkjet printer having a printhead, the printer being responsive to digital signals and capable of printing in a multi-pass printing mode;
supplying the printer with pigment-based inks;
supplying the printer with a receiver suitable for painting photographic images;
detecting a degree of texturing of a surface of the receiver;
selecting a number of passes for the multi-pass printing mode based on the detected degree of texturing of the receiver surface; and
passing the printhead over the receiver surface in accordance with the selected number of passes.

2. The method of printing as set forth in claim 1, wherein:
if the degree of texturing of the receiver surface is within a preferred range, the selecting step includes selecting a first number of passes; and
if the degree of texturing is outside of said preferred range, the selecting step includes selecting a second number of passes, wherein the second number of passes is greater than the first number of passes.

3. The method of printing as set forth in claim 1, wherein said receiver is a porous type receiver.

4. The method of printing as set forth in claim 1, wherein said printer is further capable of printing in a bi-directional printing mode.

5. The method of printing as set forth in claim 2, wherein said preferred range corresponds to a surface roughness (RMS) between 1.0 and 2.5 microns.

6. The method of printing as set forth in claim 1, wherein the detecting step includes:
identifying a mark on the receiver sheet.

7. The method of printing as set forth in claim 1, wherein the detecting step includes:
illuminating an area of the receiver sheet; and
detecting a reflectivity of light from the illuminated area.

8. A method of printing, the method comprising:
providing a carriage-type inkjet printer having a printhead, the printer being responsive to digital signals and being capable of printing in a multi-pass mode;
supplying the printer with pigment-based inks;
supplying the printer with a receiver suitable for printing photographic images;
detecting a degree of texturing of a surface of the receiver, wherein a degree of texturing in a preferred range represents a luster receiver surface; and
printing the image on the luster receiver surface at a relatively faster speed than a glossy receiver surface.

9. The method of printing as set forth in claim 8, wherein the printing step includes:
printing the image on the luster surface at a speed of at least 5 cm²/sec.

10. The method of printing as set forth in claim 8, wherein the printing step includes:
if the receiver surface is approximately 4″×6″, printing the image on the luster receiver surface in less than 30 seconds.
